(19) United States
(12) Patent Application Publication
(10) Pub. No.: US 2003/0049543 A1
(43) Pub. Date: Mar. 13, 2003

(54) Holographic recording medium

(75) Inventors: Stephen Elliott, Cambridge (GB); Pavel Krecmer, Cambridge (GB); Jiri Prokop, Cambridge (GB)

Correspondence Address: SUGHRUE MION, PLLC, 1010 EL CAMINO REAL, SUITE 300, MENLO PARK, CA, 94025, US

(73) Assignee: POLIGHT TECHNOLOGIES LTD., Cambridge (GB)

(21) Appl. No.: 10/165,526

(22) Filed: Jun. 7, 2002

(30) Foreign Application Priority Data
Sep. 7, 2001 (GB) 0121726.4

(51) Int. Cl. G03H 1/04; G11B 7/24

(52) U.S. Cl. 430/1; 430/2; 430/270.13; 430/945; 430/290; 359/7

(57) ABSTRACT

A holographic recording medium comprising an amorphous host material which undergoes a phase change from a first to a second thermodynamic phase in response to a temperature rise about a predetermined transition temperature; a plurality of photo-sensitive molecular units embedded in the host material and which can be orientated in response to illumination from a light source; whereby said molecular units may be so orientated when said host material is at a temperature equal to or above said transition temperature but retain a substantially fixed orientation at temperatures below said transition temperature.

### TECHNICAL FIELD OF THE INVENTION

The present invention relates generally to materials used for forming photorefractive holographic recording media. The invention relates in particular to a group of materials, which are usable as non-volatile WORM (write once read many) photorefractive holographic media.

### DESCRIPTION OF RELATED ART

Data storage based on two-dimensional (2D) memories, such as optically read/write pits, grooves or magnetic domains are reaching the theoretical limits of the given materials. New techniques are being sought in order to decrease the price per megabyte and increase the data storage capacity and speed of data recording and retrieval of near-future disk drives by several orders of magnitude. The technical solutions to the problem are essentially three-fold. Firstly, decreasing the pit and groove sizes to several nanometres would reach the limit of 10¹⁰-10¹² bits/mm². Such a solution is, however, inevitably limited by costly precision mechanics, need for special environments (high-vacuum or pure liquid state) and most importantly, extra long access time to stored data due to the inherent disadvantage of 2D technology—very slow, serial reading.

The second technical solution to the increasing demands for data-storage systems is being developed on the basis of three-dimensional optical writing of pits and grooves into a series of multi-layers. Instead of one layer in today's CDs or two layers in today's DVDs, multi-layer disks are being considered using, for example, photorefractive polymers as discussed by D. Day, M. Gu and A. Smallridge (Use of two-photon excitation for erasable-rewritable three-dimensional bit optical data storage in a photorefractive polymer, Optics Letters 24 (1999) 948) or fluorescent materials. This technical solution to the data-storage problem also has severe disadvantages such as the limited number of sensitive layers due to overlapping problems (noise due to interference and scattering) and still, most importantly, slow serial data processing.

The third category of technical approach to data-storage systems for future recording media is in holographic data recording and retrieval. There has been growing interest in the use of holography for information storage due to its massively parallel data processing and prospect of reaching the ultimate theoretical limits of the material used for the storage. Used for storage of digital information, holography is now regarded as a realistic contender for functions now served by opto-magnetic materials or optically written phase-change CD-ROMs and DVD-ROMs.

It is generally accepted that a suitable recording medium is not yet commercially available. Virtually any photo-sensitive material can be used for holographic recording; however, long-time data storage, sensitivity, cost, speed of recording and developing of the holograms are only some of the issues which limit the available materials to a few which are potentially useful in the field of holographic data storage. Typical materials extensively used in, for example, art holography, such as silver-halide materials, dichromated gelatin, bacteriorhodopsin etc. are generally unsuitable for data storage, as they typically require additional processing steps such as wet development. Thus, there are, in principle, two major groups of materials being extensively studied at present.

Ion-doped inorganic photorefractive crystals, such as lithium niobate, have served for laboratory use for many years. Interfering light beams of suitable wavelength generate bright and dark regions in the electro-optic crystal and charge carriers—usually electrons—are excited in the bright regions and become mobile. They migrate in the crystal and are subsequently trapped at new sites. By these means electronic space-charge fields are set up that give rise to a modulation of refractive index via the electro-optic effect.

Disadvantages of these materials include high cost and poor sensitivity resulting in a need for very high light power densities, limited refractive index changes (up to 10⁻³), restriction to small samples (single crystals), the volatility of the stored data and the necessity of thermal fixing by heating the crystal to 100-129° C. after recording and the danger of noise due to damage inflicted during read-out.

Polymer recording is promising and is gaining increased popularity due to the simple method of preparation and relatively low cost. Several physical principles are utilised in polymer recording. Photopolymers or photoaddressable polymers react to light with a refractive index change caused by a change in their molecular configuration resulting from polymerisation. Photorefractive polymers utilise the same electro-optic effect as described above in the case of photorefractive crystals.

The major disadvantage of the monomer-polymer type material is the significant distortions of the holograms due to polymer shrinkage during polymerisation. Photoaddressable—photochromic and photodichroic polymers that undergo a change in isomer state after two-photon absorption are the subject of extensive study. These materials are reversible and relatively fast (msec); however, disadvantages typically include relatively fast dark relaxation, short dark storage time and the requirement of coherent UV light sources. Photorefractive polymers exhibit quite a high dynamical range with low intensity illumination, but still suffer from disadvantages like problematic preparation of thick samples, need for development of non-destructive readout and the necessity to apply a high electrical field for the transport and charge separation.

Organic polymers are generally also limited in having relatively low light intensity thresholds due to possible overheating (resulting in chemical decomposition).

There are six basic principles utilized in chalcogenide glasses, which can be potentially used for holographic recording:

1. the phase change (photocrystallisation),

2. photodoping of chalcogenides with metallic materials which are in direct contact with the sample (e.g. silver, copper etc.)

3. photoinduced expansion and contraction of the glassy matrix,

4. wet etching of the exposed/nonexposed areas of the chalcogenide glass in solvents

5. photoinduced anisotropy (the change of refractive index (birefringence) and absorption coefficient (dichroism) upon absorption of polarized light),

6. photodarkening/photobleaching (the change of absorption coefficient and refractive index upon absorption of unpolarized light),

The first group consists of optical recording media, which exhibit a phase-change in their composition upon illumination or heating. It is well known that some kinds of Te-based alloy film undergo comparatively easily a reversible phase transition by irradiation of a laser beam. Since, among them, the composition rich in Te-component makes it possible to obtain an amorphous state with a relatively low power of laser, the application to recording medium has been so far tried. For example, S. R. Ovshinsky et al. had first disclosed in U.S. Pat. No. 3,530,441 that such thin films as Te₈₅ Ge₁₅ and Te₈₁Ge₁₅S₂Sb₂ produce a reversible phase-transition when exposed to light with high-density energy such as a laser beam. A. W. Smith has also disclosed a film of Te₉₂Ge₃As₅ as a typical composition, and he has clarified that it could make recording (amorphization) and erasing (crystallization) runs of about 10⁴ times, and erasing (Applied Physics Letters, 18 (1971) p. 254). But since the crystalline phase causes a high light scattering, these are generally materials not well suited for holographic recording.

Many studies have been made on light-sensitive materials, which make use of the photodoping phenomenon. When a light-sensitive recording material comprising laminated layers of a chalcogenide film and a metallic layer are subjected to appropriate irradiation, a metal diffusion in the chalcogenide (photodoping) is caused in the irradiated areas, thus yielding an image corresponding to the light irradiation pattern. [Soviet Physics Solid State, Vol. 8, p. 451 (1966), U.S. Pat. Nos. 3,637,381 and 3,637,383, Japanese Patent Publication 6,142/72]. The resulting image can either be used as such utilizing the absolute contrast between fully opaque (non-irradiated) and transparent areas (illuminated) of the sample (amplitude image) or make use of the diffusion implicated differences in the solubility of the exposed and non-exposed areas in suitable solvents. Although this is potentially interesting in write-once-read-many type of memories, this effect is generally slow. Another disadvantage of these materials is firstly the high mobility of the small metal-ions (mostly Ag) in the host material, which causes a relative fast degradation of the optical properties of the sample. Secondly, in order to make use of the refractive index changes in the material, the non-dissolved metal at the non-illuminated areas of the sample has to be removed in an additional process step [C. W. Slinger, A. Zakery, P. J. S. Ewen and A. E. Owen, Photodoped chalcogenides as potential infrared holographic media, Applied Optics 31 (1992) 2490].

The photoinduced expansion/contraction of the glassy matrix can be used for the formation of relief holographic gratings in thin chalcogenide films. Though it might play an important role in fundamental understanding of photostrucural changes, it is rather a negative effect affecting the process of holographic recording in chalcogenide glasses. Fortunately it requires high exposure energies (200-300 J/mm²) to significantly affect the flatness of the sample surface. [V. Paylok, Appl. Phys. A 68 (1999) 489, S. Ramachandran, IEEE Photonics Tech. Lett.,8, 1996].

Wet etching of photo-induced holograms in chalcogenide glasses—T. Sakai and Y. Utsugi [Opt. Comm. 20 (1977) 59] copied holograms using amorphous chalcogenide semiconductor films as a master, utilizing the feature of a chalcogenide glass to act as an effective inorganic photoresist, where illuminated or unilluminated areas of the sample are vulnerable to solvents (both positive and negative processes being used). This effect has the potential for use in making holographic master elements for polymer endorsing; however, it is generally unsuitable for holographic data storage, as it requires long times for the development of the recorded data.

Photoinduced anisotropy, optical changes under illumination with polarized light (i.e. optically induced birefringence and dichroism) are the next group of optical properties in chalcogenide glasses used for hologram writing. A change of refractive index of about ˜3.10⁻³ in a As₂S₃ film was first observed in 1977 by Zhdanov and Malinovsky [V. G. Zhdanov and V. K. Malinovsky, Pis'ma Zh. Tehn. Fiz. 3 (1977) 943], and nearly 100 research papers have been published on the subject since. The structural changes associated with photoinduced anisotropy are the subject of speculations; however, it is generally accepted that the structural origin of the photoinduced anisotropy is different in nature from that of scalar photodarkening. Reorientation of charged atomic defects, orientation of crystalline units in the glassy matrix and change in bond-angle distributions are all being equally considered as the origin of photoinduced anisotropy. The first holographic recording in chalcogenide glasses based on photoinduced anisotropy was performed by Kwak at al [C. H. Kwak, J. T. Kim and S. S. Lee, Scalar and vector holographic gratings recorded in a photoanisotropic amorphous As₂S₃ thin films, Optics Lett. 13 (1988) 437]. The maximum diffraction efficiency (˜0.2%) with an Ar-ion laser beam (514 nm) and 50 mW/cm² light intensity, was reached in order of tens of seconds in C. H. Kwak, J. T. Kim and S. S. Lee, Scalar and vector holographic gratings recorded in a photoanisotropic amorphous As₂S₃ thin films, Optics Lett.13 (1988) 437. The effect is essentially reversible by changing the orientation of linearly polarized light to the orthogonal direction to that of the inducing beam. Similar characteristic performances of holographic writing of diffraction elements (diffraction efficiency of order of <5%) with polarized light have been reported later.

Scalar photodarkening/photobleaching (i.e. a photoinduced change in optical properties independent of the polarization of the inducing light) is believed in the related art to be caused by one or more combinations of the following processes: atomic bond scission, change in atomic distances or bond-angle distribution, or photoinduced chemical reactions such as

2As₂S₃<->2S+As₄S₄

Most recording materials for holograms based on chalcogenide glasses take advantage of differences in the light absorption between irradiated areas and non-irradiated areas [Applied Physics Letters, Vol. 19, p. 205 (1971) U.S. Pat. No. 3,923,512, UK Patent GB-1387 177]. The method comprises exposing a chalcogenide layer to a pattern of light having wavelengths less than the band-gap radiation wavelength of the material whereby the optical density of the material is increased or decreased in the areas exposed to light to form a visible image.

The changes in absorption coefficient are mainly accompanied by a change in refractive index. This is typically greater than that in photorefractive crystals or polymers and can reach up to Δn˜0.2-0.3 (for comparison Fe-doped LiNbO₃ ferroelectric crystals has Δn˜10⁻⁴). In the early 1970s, reversible photoinduced shifts of the optical absorption of vitreous As₂S₃ films were reported and used for hologram storage in these materials [U.S. Pat. No. 3,923,512, Ohmachi, Appl. Phys. Lett., 20 (12) 1972, J. S.,Berkes J.Appl.Phys, 42, 5908, K. Tanaka, Solid St. Commun., 11,1311]. Typical diffraction efficiencies of several percent for exposure with 15 mW laser power (Ar-ion laser) in 10 sec, with stable dark data storage over 2,500 hours, were reported in As₂S₃ films [S. A. Keneman, Appl.Phys.Lett. 19 (6) 1971]. Similar results of holographically written gratings (or other holographic elements) based on the principle of photodarkening/photobleching in chalcogenide glasses were later reported by various researchers [PNr.SU474287, SU697958-1980, SU704396-1982, SU-1100253, SU1833502-1995, O.Salminen, Opt. Commun.116 (1995) 310,]. Since the maximum diffraction efficiency of an amplitude grating (based on changes in optical density) is principally much lower than that of a phase grating, it is desirable to minimize the light attenuation caused by a high absorption of the chalcogenide layer.

As the required data storage density rapidly increases, the need for thick recording media becomes inevitable. The effective areal storage density can be significantly increased by recording of multiple, independent pages of data in the same recording volume. This process, in which the holographic structure for one page is intermixed with the recorded structure of each of the other pages, is referred to as multiplexing. Retrieval of an individual page with minimum crosstalk from the other pages is a consequence of the volume nature of the recording and its behavior as a highly tuned structure. This so called Bragg effect is the cause for a decrease in diffraction efficiency by changing the angle or wavelength between recording and playback beams. The point at which the diffraction efficiancy becomes zero depends on the recording angles, initial wavelength and optical thickness of the recording material. For a given recording configuration, altering the thickness plays the central role. As the thickness increases, the recorded structure becomes more highly tuned such that smaller mismatches can be tolerated.

According to Kogelnik's coupled wave theory [H. Kogelnik, Bell.Syst. Tech. J.48, 2909 (1996)] multiple holograms can be stored in a 10 μm thick recording medium (λ=532 nm, θₑₓₜ(object b.)=θₑₓₜ(reference b.)=45°, n=1.5 in increments of 3° while a 100 μm thick medium allows storage in 0.3° increments. Since the diffraction efficiency η of a hologram is defined as the ratio of the diffracted power to the incident power, a small optical absorption coefficient α is also desirable to achieve high diffraction efficiencies. The major drawback of the proposed recording media utilising chalcogenide glasses is their high absorption (compositions from systems As—S, As—Se, As—Ge—S, As—Ge—Se, Ge—Se ) or low sensitivity (compositions from systems Ge—S, Ge—Sb—S) for the wavelength of the commercially most available Nd-YAG laser (λ=532 nm). If this problem were to be overcome, chalcogenides could be used for optical data storage in future optical discs. It is thus an aim of the present invention to at least partly mitigate the above mentioned problems.

The object of this invention is the utilization of a highly photosensitive composition of an amorphous chalcogenide material in the form of relatively thick film d>100 μm) for the preparation of a volume holographic recording medium with high diffraction efficiency, which allows multiple holograms to be stored, the material having a high level of optical transmission at the wavelength of interest.

### SUMMARY OF THE INVENTION

According to the present invention, a holographic recording medium comprises a chalcogenide glass comprising at least sulphur in combination with phosphorus, which undergoes a photostructural change in response to illumination with bandgap or sub-bandgap light resulting in a change of refractive index of the chalcogenide glass.

Preferably, the holographic recording medium comprises a substrate and an amorphous layer of the chalcogenide glass.

The present invention also provides the use of a chalcogenide glass comprising at least sulphur in combination with phosphorus as a holographic recording medium.

The present invention also provides a method of manufacturing a holographic recording medium comprising the step of preparing an amorphous layer of as evaporated chalcogenide glass comprising at least sulphur in combination with phosphorus.

The present invention further provides a method of holographic recording comprising the steps of:

providing a holographic recording medium comprising an amorphous layer of a chalcogenide glass comprising at least sulphur in combination with phosphorus,

selectively illuminating the holographic recording medium with bandgap or sub-bandgap light thereby inducing a photostructural change resulting in a change of refractive index of the chalcogenide glass.

According to the present invention, a chalcogenide glass comprises at least sulphur in combination with phosphorus, which undergoes a photostructural change in response to illumination with bandgap or sub-bandgap light resulting in a change of refractive index of the chalcogenide glass.

The present inventors have found that the addition of phosphorus to a sulphur-based chalcogenide glass produces a glass having properties which are advantageous as a holographic recording medium. The bandgap of the material is increased in energy compared to previously used chalcogenide glasses such that it can be used as a holographic recording medium using a commercially available frequency doubled Nd:YAG laser (wavelength λ=532 nm).

In chalcogenide glasses which have previously been used as holographic recording media, the sensitivity of the glass to a Nd:YAG laser has been very low and at the same time these glasses have typically a very high optical absorption at λ=532 nm of Nd:YAG laser light. If known chalcogenide glasses were to be used in a commercial “holodrive” they would require the use of very expensive tunable pulsed lasers of lower energy (ie longer wavelength). Ar ion lasers (514 nm) which have previously been used would be of no practical use, as it is not possible to pulse such lasers. Pulsing is crucial for commercial holographic data storage as fast writing speeds are dependant on pulsing of the laser. The sensitivity of the recording medium of the present invention at the wavelength of a Nd:YAG laser is very high. Such lasers are relatively cheap and can be pulsed. The present invention potentially can achieve the fast writing speeds which are essential in a commercially viable holographic storage medium. The present inventors believe that speeds of 1 Mbit per 10 ns pulse can be achieved.

Furthermore, the holographic recording medium of the present invention also has high transparency at the wavelength of commercially available Nd:YAG lasers. This allows thicker layers to be used, increasing the amount of data which can be stored by multiplexing more pages of data. Other glasses do not have sufficiently good transmission characteristics to enable thick (>100 μm) films to be used.

Preferably, the chalcogenide glass has a bandgap corresponding to a wavelength of less than or equal to 532 nm. More preferably, the bandgap is slightly below 532 nm so that the transparency of films of thickness ≧100 μm is greater than, say, 50%. This increases the depth of absorption without substantially reducing the sensitivity. This makes the material sensitive to wavelengths in the green part of the spectrum, and highly sensitive to light from a Nd:YAG laser.

The chalcogenide glass used in the present invention is a S-based chalcogenide glass rather than a Se or Te-based chalcogenide glass, as Se or Te-based glasses tend to have bandgaps which are at too low energies (ie longer wavelengths, in the red or infrared parts of the spectrum) for the purposes of the invention utilizing a green (532 nm) laser.

Preferably, the chalcogenide glass further comprises an element selected from the list:

As, Ge, Ga, B, Si, Al, Zn.

It has been found that chalcogenide glasses additionally containing these light elements have higher energy bandgaps and are particularly effective as holographic recording media. Preferably, the chalcogenide glass further comprises arsenic.

Preferably, the chalcogenide glass consists of sulphur, phosphorus and arsenic. Such a glass has found to be a particularly effective holographic recording medium compared to As₂S₃, which has been well studied.

### BRIEF DESCRIPTION OF THE DRAWINGS

Examples of the present invention will now be described in detail with reference to the accompanying drawings in which:

FIG. 1 shows a ternary diagram of As—P—S compositions in accordance with embodiments of the present invention;

FIG. 2 illustrates diffraction efficiency of a sample of As₂₈S₆₆P₆;

FIG. 3 shows a holographic image of the US Air Force military resolution target recorded in a thin film of As₂₈S₆₆P₆;

FIG. 4 shows a holographic recording medium in accordance with the present invention; and

FIG. 5 shows an apparatus used for recording the holographic image of FIG. 3.

### DETAILED DESCRIPTION OF THE DRAWINGS

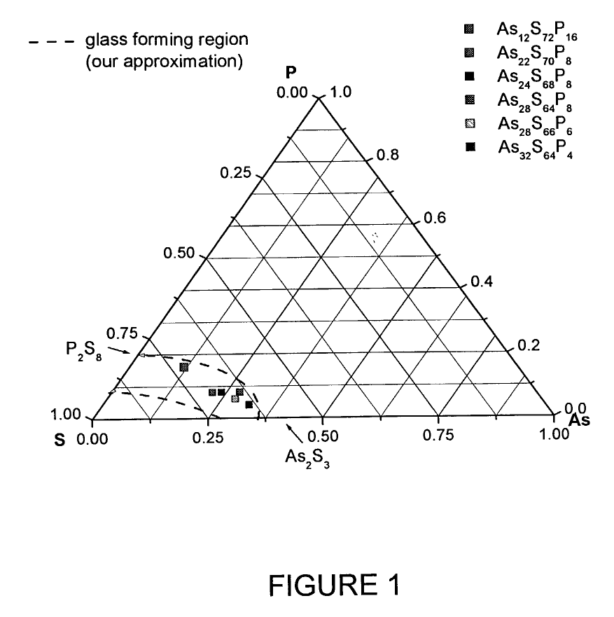

FIG. 1 is a ternary diagram of an As—P—S system, on which approximate boundaries of the glass-forming region are marked. Six example compositions are illustrated, As₁₂S₇₂P₁₆, As₂₂S₇₀P₈, As₂₄S₆₈P₈, As₂₈S₆₄P₈, As₂₈S₆₆P₆ and As₃₂S₆₄P₄. As a comparative example, As₂S₃ is also illustrated. All the example compositions according to the present invention which include a component of phosphorus were found to have higher bandgaps and increased sensitivity to a Nd:YAG laser compared to the known and well studied As₂S₃ glass. All the examples also had good transparency.

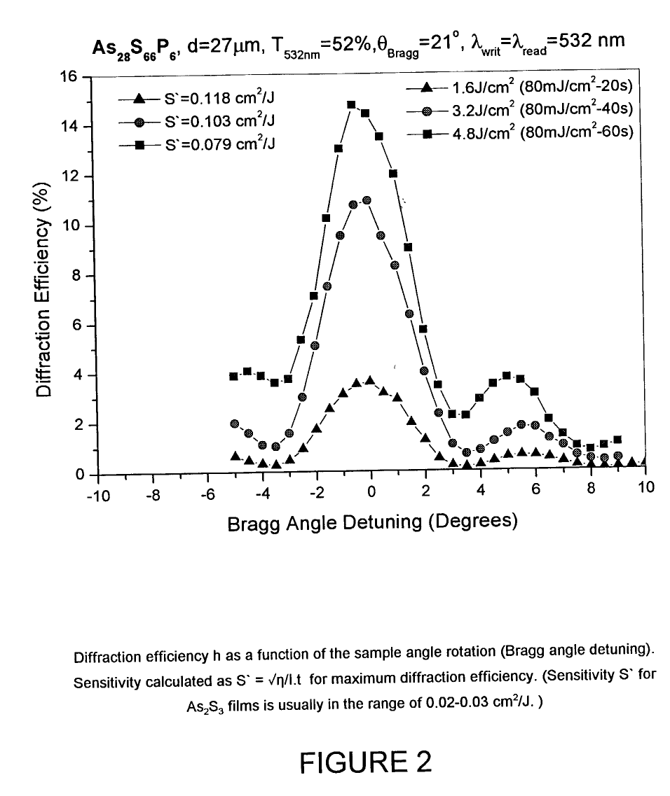

FIG. 2 illustrates the diffraction efficiency of one example, As₂₈S₆₆P₆ at three different exposure times of 20 s, 40 s and 60 s using a Nd:YAG laser of intensity 80 mW/cm². As can be seen, the maximum diffraction efficiency reaches a value of about 15% at an exposure of 4.8 J/cm². Previously, the maximum diffraction efficiency obtained with As₂S₃ was typically 0.2% with an Ar-ion laser beam (514 nm) and 50 mW/cm² light intensity, in an exposure time of the order of tens of seconds.

Sensitivity S′ of a sample can be calculated as:

S′=√η/I.t

where I is intensity of the light source, t is exposure time, and η is the maximum diffraction efficiency. Sensitivities of about 0.1 cm²/J were obtained. For comparison, typical sensitivity values for As₂S₃ samples are in the range 0.02-0.03 cm²/J.

It is believed that the increased sensitivity is related to the formation of thermodynamically stable P₄S₄ and P₄S₃ molecules in the glass. Each of these molecules, due to their inherent atomic structure, possess a strong dipole moment (inherent or induced). At first, these dipole moments are randomly oriented in the amorphous network. However, it is believed that during the illumination with light, those dipole moments (or molecules) being favorably oriented would couple with interacting photons and the coupling would lead to breakage of the molecules. Atoms of these broken molecules would subsequently integrate into the amorphous structure and would not contribute to a strong overall dipole moment (being the sum of all dipole moments of all molecules and atoms in the amorphous network). During the course of illumination, preferential depletion of the molecules in one direction, would thus result in strong inhomogeneity in the refractive index, the refractive index being strongly linked to dipoles.

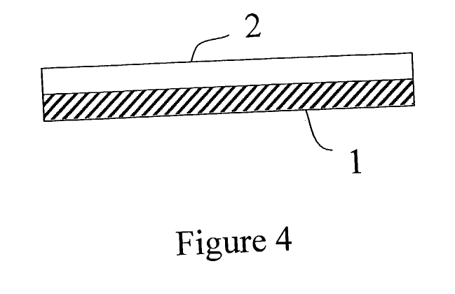

FIG. 4 illustrates the construction of a holographic recording medium having a substrate 1 which may be any suitable transparent material such as polycarbonate or optical glass and an amorphous layer 2 of the chalcogenide glass.

The amorphous layer can be formed by thermal evaporation in vacuum from a bulk material already containing phosphorous onto the substrate. Other physical or chemical methods are also possible eg chemical vapor deposition, sputtering or laser ablation.

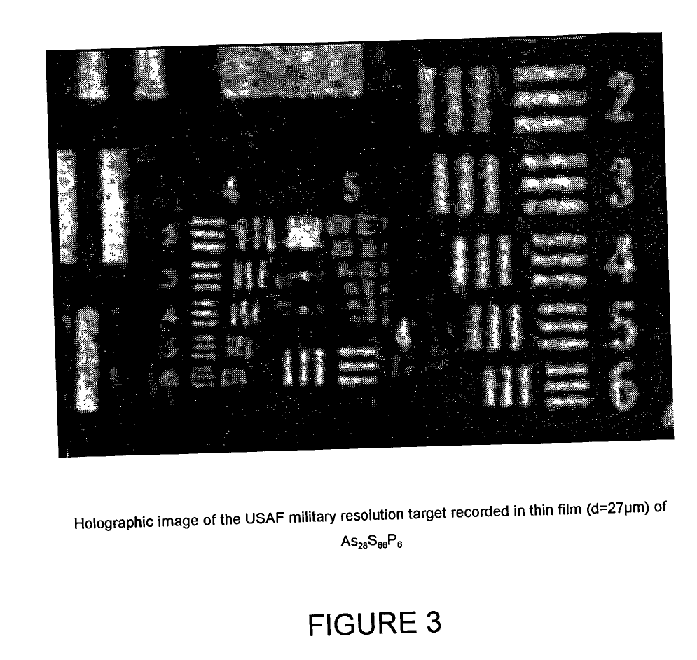

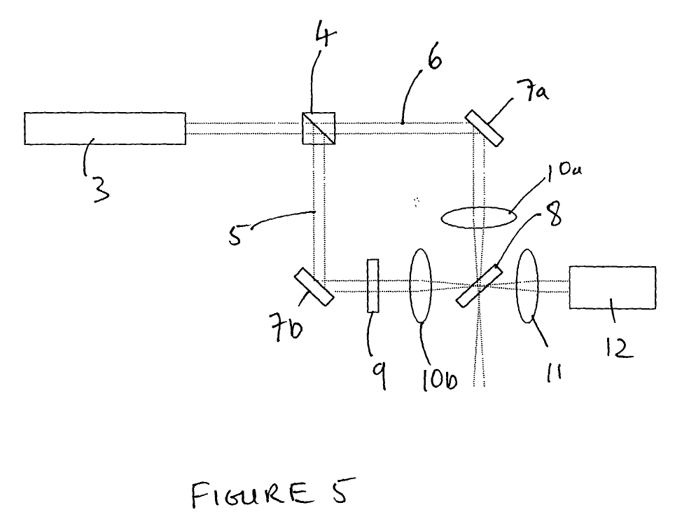

FIG. 5 illustrates the apparatus used to record the hologram of FIG. 3. A beam from an Nd:YAG laser 3 is split by beam splitter 4 into object beam 5 and reference beam 6, which are reflected by mirrors 7a, 7b. The object beam 5 passes through the image plate 9, in this case being the US Air Force military resolution target. Both beams are focused by lenses 10a, 10b onto the sample 8, and the interference pattern of the two beams is recorded in the sample 8. A lens 11 focuses the image onto a CCD camera 12 to record the image.

1. A holographic recording medium comprising a chalcogenide glass comprising at least sulphur in combination with phosphorus, which undergoes a photostructural change in response to illumination with bandgap or sub-bandgap light resulting in a change of refractive index of the chalcogenide glass.

2. A holographic recording medium according to claim 1, wherein the photostructural change is substantially irreversible.

3. A holographic recording medium according to claim 1, wherein the photostructural change is the breakdown of P₄S₄ and/or P₄S₃ molecules in the glass.

4. A holographic recording medium according to claim 1, wherein the chalcogenide glass has a bandgap at or below 532 nm.

5. A holographic recording medium according to claim 1, wherein the chalcogenide glass further comprises an element selected from the group consisting of As, Ge, Ga, B, Si, Al, Zn.

6. A holographic recording medium according to claim 1, wherein the chalcogenide glass further comprises arsenic.

7. A holographic recording medium according to claim 1, wherein the chalcogenide glass consists of sulphur, phosphorus and arsenic.

8. A holographic recording medium according to claim 1 comprising a substrate and an amorphous layer of the chalcogenide glass.

9. A holographic recording medium according to claim 8, wherein the layer of chalcogenide glass has a thickness greater than 100 μm.

10. A holographic recording medium according to claim 9, wherein the layer has a transmission of greater than 50% for light at a wavelength of 532 nm.

11. The use of a chalcogenide glass comprising at least sulphur in combination with phosphorus as a holographic recording medium.

12. A method of manufacturing a holographic recording medium comprising the step of preparing an amorphous layer of evaporated chalcogenide glass comprising at least sulphur in combination with phosphorus.

13. A method of holographic recording comprising the steps of:
providing a holographic recording medium comprising an amorphous layer of a chalcogenide glass comprising at least sulphur in combination with phosphorus,
selectively illuminating the holographic recording medium with bandgap or sub-bandgap light thereby inducing a photostructural change resulting in a change of refractive index of the chalcogenide glass.

14. A method of holographic recording according to claim 13, wherein the chalcogenide glass further comprises an element selected from the group consisting of As, Ge, Ga, B, Si, Al, Zn.

15. A method of holographic recording according to claim 13, wherein the chalcogenide glass further comprises arsenic.

16. A method of holographic recording according to claim 13, wherein the chalcogenide glass consists of sulphur, phosphorus and arsenic.

17. A method of holographic recording according to claim 13, wherein the illuminating light has a wavelength of substantially 532 nm.

18. A method of holographic recording according to claim 13, wherein the holographic recording medium is illuminated by a frequency doubled Nd:YAG laser.

19. A method of holographic recording according to claim 13, wherein the holographic recording medium is illuminated by a pulsed laser.

20. A method of holographic recording according to claim 13, wherein the photostructural change is substantially irreversible.

20. A method of holographic recording according to claim 13, wherein the photostructural change is substantially irreversible.

21. A method of holographic recording according to claim 13, wherein the illuminating light causes a breakdown of P₄S₄ and/or P₄S₃ molecules in the glass.

22. A method of holographic recording according to claim 13, wherein the recording is performed substantially at room temperature.

23. A chalcogenide glass comprising at least sulphur in combination with phosphorus, said chalcogenide glass undergoing a photostructural change in response to illumination with bandgap or sub-bandgap light resulting in a change of refractive index of the chalcogenide glass.
